(19) United States
(12) Patent Application Publication
(10) Pub. No.: US 2026/0127956 A1
(43) Pub. Date: May 7, 2026

(54) Proximity Alert System

(71) Applicants: Ali T. Alouani, Cookeville, TN (US); John R. Meeks, Clarksville, TN (US)

(72) Inventors: Ali T. Alouani, Cookeville, TN (US); John R. Meeks, Clarksville, TN (US)

(21) Appl. No.: 18/937,152

(22) Filed: Nov. 5, 2024

(51) Int. Cl. G08B 21/24; G08B 7/06; G08B 21/18; G08B 25/10

(52) U.S. Cl. CPC G08B 21/24; G08B 7/06; G08B 21/182; G08B 25/10

(57) ABSTRACT

A proximity alert system that includes a proximity device having a transmitter adapted to provide a wireless signal, and an alert device having a receiver adapted to receive the wireless signal, a signal processor adapted to analyze the wireless signal and determine a distance between the proximity device and the alert device, a memory adapted to hold a maximum distance value, a processor adapted to compare the distance to the maximum distance value, and an alert module adapted to provide an indication when the distance exceeds the maximum distance value.

### FIELD

This invention relates to the field of proximity alert systems. More particularly, this invention relates to providing an alert to a user that an item has been left behind.

### INTRODUCTION

It is not unusual for a user to leave behind an item such as a cell phone, wallet, purse, or laptop in a public place such as a restaurant, coffee shop, medical office, or shopping mall. In many instances, the item is expensive, contains valuable information, holds sentimental value, or is otherwise of value to the user.

If the user is not alerted soon after leaving the item, it may be picked up by someone else before the user realizes that the item was left behind. Even if the item is not taken by another, the user might not remember where the item was left behind. In either event, the user has lost the item.

What is needed, therefore, is system that tends to reduce issues such as that described above, at least in part.

### SUMMARY

The above and other needs are met by a stand alone proximity alert system that includes a proximity device having a transmitter adapted to provide a wireless signal, and an alert device having a receiver adapted to receive the wireless signal, a signal processor adapted to analyze the wireless signal and determine a distance between the proximity device and the alert device, a memory adapted to hold a maximum distance value, a processor adapted to compare the distance to the maximum distance value, and an alert module adapted to provide an indication when the distance exceeds the maximum distance value.

In some embodiments, the maximum distance value is user-selectable. In some embodiments, the alert device is a user-wearable device. In some embodiments, the alert device is a smart watch. In some embodiments, the alert device is a cellphone. In some embodiments, the transmitter is a first transceiver and the receiver is a second transceiver. In some embodiments, the transmitter and the receiver communicate directly, one with another, without use of any other devices. In some embodiments, the wireless signal is a Bluetooth signal. In some embodiments, the wireless signal is an RFID signal. In some embodiments, the wireless signal is a Zigbee signal. In some embodiments, the wireless signal is a Z-Wave signal. In some embodiments, the wireless signal is an ultra-wideband signal. In some embodiments, the indication is a vibration from a vibrator. In some embodiments, the alert is a light from an illuminated lamp. In some embodiments, the alert is an audible tone from a speaker. In some embodiments, the alert is a phone call from a cellular radio.

According to another aspect of the disclosure, there is described as proximity alert system that includes a proximity device, having a first transceiver adapted to receive a first wireless signal from an alert device, a signal processor adapted to analyze the first wireless signal and determine a distance between the proximity device and the alert device, a memory adapted to hold a maximum distance value, and a processor adapted to compare the distance to the maximum distance value. The first transceiver is further adapted to send a second wireless signal to the alert device when the distance exceeds the maximum distance value. The alert device includes a second transceiver adapted to receive the second wireless signal from the proximity device and send the first wireless signal to the proximity device, and an alert module adapted to provide an indication upon receipt of the second wireless signal.

In some embodiments according to this aspect of the disclosure, the maximum distance value is user-selectable. In some embodiments, the alert device is a smart watch. In some embodiments, the proximity device is a cellphone.

### BRIEF DESCRIPTION OF THE DRAWINGS

Further advantages of the invention are apparent by reference to the detailed description when considered in conjunction with the Figures, which are not to scale so as to more clearly show the details, wherein like reference numbers indicate like elements throughout the several views, and wherein:

FIG. 1A depicts an alert system for a left-behind item, including a proximity device and an alert device, where the proximity device is within a user-selectable distance from the alert device.

FIG. 1B depicts the alert system for the left-behind item, including the proximity device and the alert device, where the proximity device is outside of the user-selectable distance from the alert device, according to an embodiment of the present disclosure.

FIG. 2 depicts a functional block diagram for elements of at least one of the proximity device and the alert device, according to an embodiment of the present disclosure.

FIG. 3 depicts a path taken by the user after leaving the proximity device, which path is used for calculating a distance between the proximity device and the alert device, according to an embodiment of the present disclosure.

### DESCRIPTION

With reference now to the drawings, there are depicted all of the claimed elements of the various embodiments, although all claimed embodiments might not be depicted in a single drawing. Thus, it is appreciated that not all embodiments include all of the elements as depicted, and that some embodiments include different combinations of the depicted elements. It is further appreciated that the various elements can all have many different configurations, and are not limited to just the configuration of a given element as depicted. As indicated above, the elements of the drawings as depicted are not to scale, even with respect one to another, and relative size or thickness of one element cannot be determined by the aspect ratios of that element or with reference to any dimension of another element.

### Brief Overview

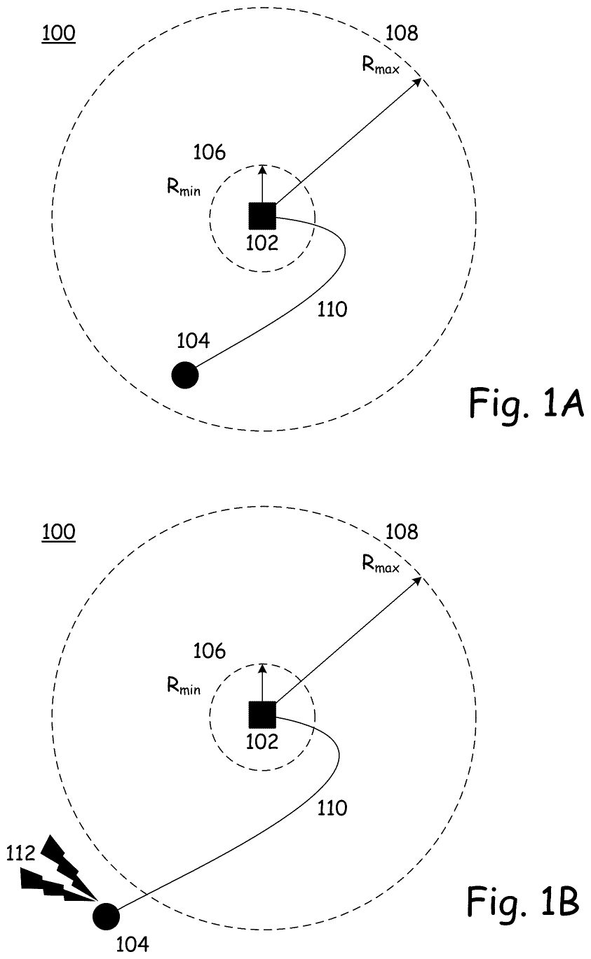

With reference now to FIGS. 1A and 1B, there is depicted an alert system 100, including a proximity device 102 and an alert device 104. The alert system 100 produces an alert 112 when the alert device 104 is farther away from the proximity device 102 than a maximum distance 108. In one embodiment, distance calculations only start once the wearable crosses the virtual circle 306.

Thus, a user of the system 100 could walk around within the maximum distance area 108 without triggering the alert 112 from the alert device 104, but as soon as the user crossed outside of the maximum distance 108, the alert device 104 would produce an alert 112.

In this manner, when the proximity device 102 is attached or otherwise proximate to an item of value to the user, and the alert device 104 is with the user, the alert system 100 will inform the user when the item of value has been left behind, and the user has wandered away from the item by more than a maximum distance, which the user can set, in some embodiments.

So, for example, the user could associate the proximity device 102 with his cellphone, and his smart watch could be enabled to act as the alert device 104. When the user leaves his cellphone behind and goes further than a maximum distance that he has set, his/her smartwatch alerts him, such as with a sound, an illuminated dial, or a vibration, that he/she is further from his cellphone than he/she wants to be.

In various embodiments, the alert system 100 does not depend upon any intermediate system to relay the wireless communications between the proximity device 102 and the alert device 104. In this manner, the alert system 100 will work even when there is no cellular service or wi-fi service, or other intermediary protocol services available.

### DETAILED EMBODIMENTS

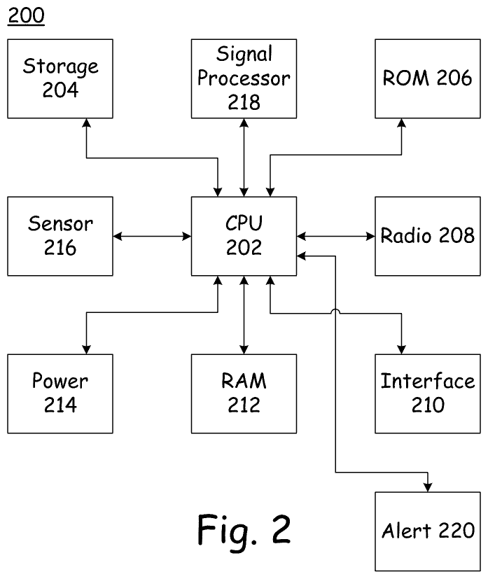

With reference now to FIG. 2, there is depicted one embodiment of a computerized apparatus 200 capable of performing the actions as described herein. The apparatus 200 is at least one of a special purpose computing device, a tablet computer, a smart phone, a smart watch, a component level processor, an application specific integrated circuit, or some other computing device.

In some embodiments, the sensor 216 includes at least one of an accelerometer, a heading sensor, and an inertial measurement unit. In some embodiments, the radio 208 enables data communication over a wireless connection, including at least one of RFID, Bluetooth, UWB, cellular, Zigbee, and Z-Wave. In some embodiments, the sensor 216 is embedded in the alert device 104, and in other embodiments the sensor 216 is embedded in the proximity device 102. A received signal strength indicator (RSSI) is obtained every time communication between the alert device 104 and the proximity device 102 takes place. The proximity device 102 and the alert device 104 are paired together to recognize each other.

In this embodiment, the apparatus 200 is locally under the control of the central processing unit 202, which controls and utilizes the other modules of the apparatus 200 as described herein. As used herein, the word module refers to a combination of both software and hardware that performs one or more designated function. Thus, in different embodiments, various modules might share elements of the hardware as described herein, and in some embodiments might also share portions of the software that interact with the hardware. In some other embodiments, a given module might be spread across different computer platforms, such as the proximity device 102 and the alert device 104.

The embodiment of apparatus 200 as depicted in FIG. 2 includes, in some embodiments, a non-transitory, computer-readable, data storage medium module 204 such as a flash drive, or some other relatively long-term data storage device. A read-only memory module 206 contains, for example, basic operating instructions for the operation of the apparatus 200. A radio module 208 provides a gateway for the communication of data and instructions between the apparatus 200 and other computing devices, networks, or data storage modules, such as between the proximity device 102 and the alert device 104. An interface module 210 includes, for example, keyboards, speakers, microphones, cameras, displays, and touchpads, and provides means by which the user can interact with the apparatus 200.

The alert module 220 is provided in the alert device 104, but could also be present in the proximity device 102, so that people in the vicinity of the proximity device 102, such as friends of the user, could be alerted that the proximity device 102 had been left behind by their friend, and placed in a safe place where the proximity device, and the personal item with which it is associated, would not be stolen, but would be safe until the user returned for the personal item. As mentioned elsewhere herein. In some embodiments, the alert module 220 is at least one of a vibration from a vibrator, a light from an illuminated lamp, an audible tone from a speaker, and a phone call from a cellular radio 208.

A random-access memory module 212 provides short-term storage for data, such as signal data, that is being buffered, analyzed, or manipulated and programming instructions for the operation of the apparatus 200. A power module 214 is also provided in various embodiments of the apparatus 200. In some embodiment that power module 214 is a portable power supply, such as one or more batteries. In some embodiments the power module 214 includes a renewable source, such as a solar panel or an inductive coil that are configured to provide power or recharge batteries.

In some embodiments the steps of the various functions as described herein are embodied in a computer language on a non-transitory, computer-readable, data storage medium that is readable by the apparatus 200 of FIG. 2, and that enables the apparatus 200 to implement the functions as described herein, such as a removable memory card.

In some embodiments the sensor 216 is configured to monitor at least one of device displacement, velocity, acceleration, location, and heading. In various embodiments, the sensor 216 may be at least one of a microelectromechanical system sensor, piezoresistive sensor, piezoelectric sensor, electromagnetic sensor, laser-displacement sensor, GPS receiver, and an acoustic sensor. As will be appreciated, the sensor 216 is not limited to a particular mode of collecting movement or location data. Characteristics of the data may vary based on the sensor 216 that is used in a particular embodiment.

In some embodiments the sensor 216 is not provided as a part of the apparatus 200, but instead the apparatus 200 receives all of the data to be analyzed through the radio 208, stores it in the storage module 204, and performs analytics on the data in the RAM module 212. As introduced above, the data is stored in data files, some of which might represent data capture periods that are relatively brief.

In one embodiment, the sensor 216 collects the data based on instructions from the computer 200. The instructions may include a collection period (the length of time during which data is collected) and a collection interval (the length of time between the data collection periods, when no data is collected). The collection period and the collection interval may be pre-determined default values, user selected values, or determined based on analysis of the data.

For example, the user may input, such as via interface 210, a collection period of 0.2 seconds and a collection interval of one minute, and the computer 200 may then instruct the sensor 216 to collect the distance data based on the input values. The computer 200 may receive the collected data from the sensor 216 and store each instance as a separate data file in the memory module 212 or the storage module 204. Similarly, the interface 210 can, in some embodiments, enable the user to set a minimum distance 106, within which distance no alerts would be generated, and within which a reduced number of communications between the proximity device 102 and the alert device 104 or distance calculations would be performed.

According to some embodiments, the computer 200 may be configured to instruct the sensor 216 to collect distance data in bursts and retrieve a portion of the data from the sensor 216 immediately following collection. The computer 200 may then proceed to analyze the signal data for distance as discussed elsewhere herein, and upon completing the analysis or nearing the end of the analysis, the computer 200 may instruct the sensor 216 to collect another burst of data for subsequent analysis.

### Distance Calculations

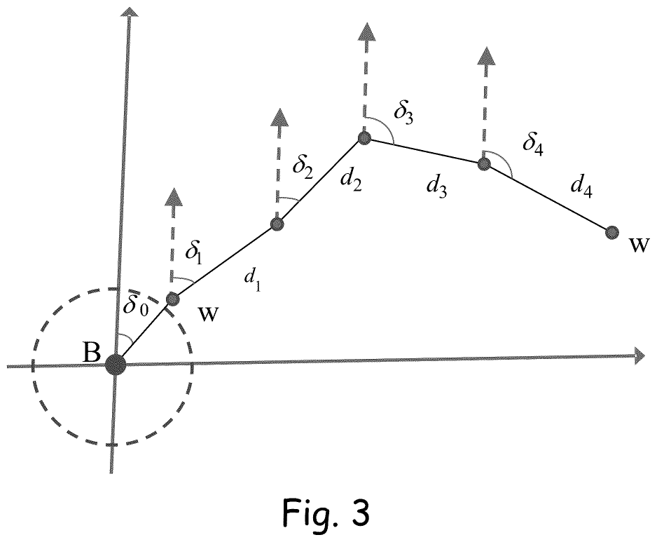

In some embodiments, the distance calculation uses an accelerometer signal from the sensor 216 to detect when the alert device 104 moves away from the proximity device 102. As an example, consider FIG. 3. Let (x₀, y₀) be the coordinates of the proximity device 102 when the alert device 104 is outside of the virtual minimum-distance circle 106. Given the sensor heading 80 at that point,

$$\begin{matrix}{x}_{0} = {R}_{min} sin ( {δ}_{0} ) , {y}_{0} = {R}_{min} cos ( {δ}_{1} ) , {d}_{0} = \sqrt{{x}_{0}^{2} + {y}_{0}^{2}} \\ {x}_{1} = {x}_{0} + {l}_{1} sin ( {δ}_{1} ) , {y}_{1} = {y}_{0} + {l}_{1} cos ( {δ}_{1} ) \\ {x}_{2} = {x}_{1} + {l}_{2} cos ( {δ}_{2} ) , {y}_{2} = {y}_{1} + {l}_{2} cos ( {δ}_{2} ) \\ {x}_{3} = {x}_{2} + {l}_{3} sin ( {δ}_{3} ) , {y}_{3} = {y}_{2} + {l}_{3} cos ( {δ}_{3} ) \\ {x}_{4} = {x}_{3} + {l}_{4} sin ( {δ}_{4} ) , {y}_{4} = {y}_{3} + {l}_{4} cos ( {δ}_{4} )\end{matrix}$$

The distance between the proximity device 102 and the alert device 104 when the user is at (x₄, y₄) is given by:

$${T}_{d} = {d}_{0} + \sqrt{{x}_{4}^{2} + {y}_{4}^{2}}$$

As used herein, the phrase “at least one of A, B, and C” means all possible combinations of none or multiple instances of each of A, B, and C, but at least one A, or one B, or one C. For example, and without limitation: Ax1, Ax2+Bx1, Cx2, Ax1+Bx1+Cx1, Ax7+Bx12+Cx113. It does not mean Ax0+Bx0+Cx0.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A proximity alert system, comprising:
a proximity device, comprising,
a transmitter adapted to provide a wireless signal, and
an alert device, comprising,
a receiver adapted to receive the wireless signal,
a signal processor adapted to analyze the wireless signal and determine a distance between the proximity device and the alert device,
a memory adapted to hold a maximum distance value,
a processor adapted to compare the distance to the maximum distance value, and
an alert module adapted to provide an indication when the distance exceeds the maximum distance value.

2. The proximity alert system of claim 1, wherein the maximum distance value is user-selectable.

3. The proximity alert system of claim 1, wherein the alert device is a user-wearable device.

4. The proximity alert system of claim 1, wherein the alert device is a smart watch.

5. The proximity alert system of claim 1, wherein the alert device is a cellphone.

6. The proximity alert system of claim 1, wherein the transmitter is a first transceiver and the receiver is a second transceiver.

7. The proximity alert system of claim 1, wherein the transmitter and the receiver communicate directly, one with another, without use of any other devices.

8. The proximity alert system of claim 1, wherein the wireless signal is a Bluetooth signal.

9. The proximity alert system of claim 1, wherein the wireless signal is an RFID signal.

10. The proximity alert system of claim 1, wherein the wireless signal is a Zigbee signal.

11. The proximity alert system of claim 1, wherein the wireless signal is a Z-Wave signal.

12. The proximity alert system of claim 1, wherein the wireless signal is an ultra-wideband signal.

13. The proximity alert system of claim 1, wherein the indication is a vibration from by a vibrator.

14. The proximity alert system of claim 1, wherein the alert is a light from an illuminated lamp.

15. The proximity alert system of claim 1, wherein the alert is an audible tone from a speaker.

16. The proximity alert system of claim 1, wherein the alert is a phone call from a cellular radio.

17. A proximity alert system, comprising:
a proximity device, comprising,
a first transceiver adapted to receive a first wireless signal from an alert device,
a signal processor adapted to analyze the first wireless signal and determine a distance between the proximity device and the alert device,
a memory adapted to hold a maximum distance value,
a processor adapted to compare the distance to the maximum distance value, and
the first transceiver further adapted to send a second wireless signal to the alert device when the distance exceeds the maximum distance value, and
the alert device, comprising,
a second transceiver adapted to receive the second wireless signal from the proximity device and send the first wireless signal to the proximity device,
an alert module adapted to provide an indication upon receipt of the second wireless signal.

18. The proximity alert system of claim 17, wherein the maximum distance value is user-selectable.

19. The proximity alert system of claim 17, wherein the alert device is a smart watch.

20. The proximity alert system of claim 17, wherein the proximity device is a cellphone.
